(19) United States
(12) Patent Application Publication
(10) Pub. No.: US 2018/0054690 A1
(43) Pub. Date: Feb. 22, 2018

(54) SINGLE CHANNEL SAMPLING FOR MULTIPLE CHANNEL VEHICLE AUDIO CORRECTION

(71) Applicant: Ford Global Technologies, LLC, Dearborn, MI (US)

(72) Inventors: Alan Peter Norton, West Bloomfield, MI (US); Matthew Dage, Ferndale, MI (US); Jake Ball, Farmington Hills, MI (US)

(21) Appl. No.: 15/238,628

(22) Filed: Aug. 16, 2016

(51) Int. Cl. H04S 7/00; H04R 5/02; H04S 3/00

(52) U.S. Cl. CPC H04S 7/301; H04R 5/02; H04S 2400/01; H04S 7/307; H04R 2499/13; H04S 3/008

(57) ABSTRACT

Systems and methods are disclosed for single channel sampling for multiple channel vehicle audio correction. An example disclosed sound system for a vehicle includes a sensing circuit, a channel manager, and a plurality of channel correctors. The example sensing circuit monitors an operational state of only one of a plurality of speakers. The example channel manager generates correction factors based on the operational state and a predicted state of the one of the plurality of speakers. Additionally, the plurality of channel correctors corresponds to the plurality of speakers. The example plurality of channel correctors apply the correction factors to signals driving the plurality of speakers.

### TECHNICAL FIELD

The present disclosure generally relates to vehicle audio systems and, more specifically, single channel sampling for multiple channel vehicle audio speaker correction.

### BACKGROUND

Vehicles often include multiple, similar speakers in for example, vehicle doors, covered by door paneling. Modern mass produced commodity vehicle loud speakers can achieve good performance. However, due to material and cost considerations, these speakers have physical limitations on their performance, particularly the linearity of the speaker output. For examples, playing sounds at a high volumes causes listener fatigue, straining, and distortion.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Systems and methods are disclosed for single channel sampling for multiple channel vehicle audio correction. An example disclosed sound system for a vehicle includes a sensing circuit, a channel manager, and a plurality of channel correctors. The example sensing circuit monitors the operational state of only one of a plurality of speakers. The example channel manager generates correction factors based on the operational state and a predicted state of the one of the plurality of speakers. Additionally, the plurality of channel correctors corresponds to the plurality of speakers. The example plurality of channel correctors apply the correction factors to signals driving the plurality of speakers by reading values of the correction factors.

An example method includes monitoring, with a sense circuit, an operational state of only one of a plurality of speakers. The example method also includes generating correction factors based on the operational state and a predicted state of the one of the plurality of speakers. Additionally, the example method includes applying the correction factors to signals driving the plurality of speakers.

An example sound system includes a plurality of speakers, a sensor, memory, and a circuit. The example sensor may be incorporated into an amplifier. The example sensor monitors an operational state of only one of the plurality of speakers. The example memory includes a virtual speaker table to store operational state and a predicted state of the one of the plurality of speakers. Additionally, the example circuit is communicatively coupled to the memory and the sensor. The example circuit generates correction factors based on the virtual speaker table, and applies the correction factors to signals driving the plurality of speakers.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle with a sound system operating in accordance with the teachings of this disclosure.

FIG. 2 is a graph depicting speaker linearity.

FIG. 3 is a block diagram of electronic components of the multi-channel vehicle audio corrector of FIG. 1.

FIG. 4 is a flowchart of a method to correct vehicle multi-channel audio with a single channel sample that may be implemented by the electronic components of FIG. 3.

FIG. 5 is a flowchart of a method to read the virtual speaker table and apply compensation to all audio channels that may be implemented by the electronic components of FIG. 3.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Commodity vehicle sound systems generally include multiples of the same model of speakers. Typically, these speakers are in the vehicle doors. As disclosed below, a multi-channel vehicle audio corrector (sometime referred to herein as an “audio corrector”) determines and applies correction factors to the audio channels to correct for listener fatigue, straining, and distortion caused by non-linearity of the speakers. The multi-channel vehicle audio corrector generates the correction factors that are applied to each of the channels of the sound system based on measurements from one of the speakers (sometimes referred to as the “sampled speaker”). The correction factors are based on a comparison of dynamic current and voltage outputs of the one of the speakers (sometimes referred to as “actual values”) and signal inputs into the sampled speaker (sometime referred to as “predicted values”). Additionally, to generate the correction factors, the multi-channel vehicle audio corrector maintains a virtual speaker table that associates the predicted values with the corresponding actual values. The correction factors are regenerated dynamically to account for aging of the speakers and changes in environmental conditions. In some examples, an event, such as an ignition switch being set to a power position other than off, triggers the multi-channel vehicle audio corrector to regenerate the correction factors by applying a signal to the sample speaker.

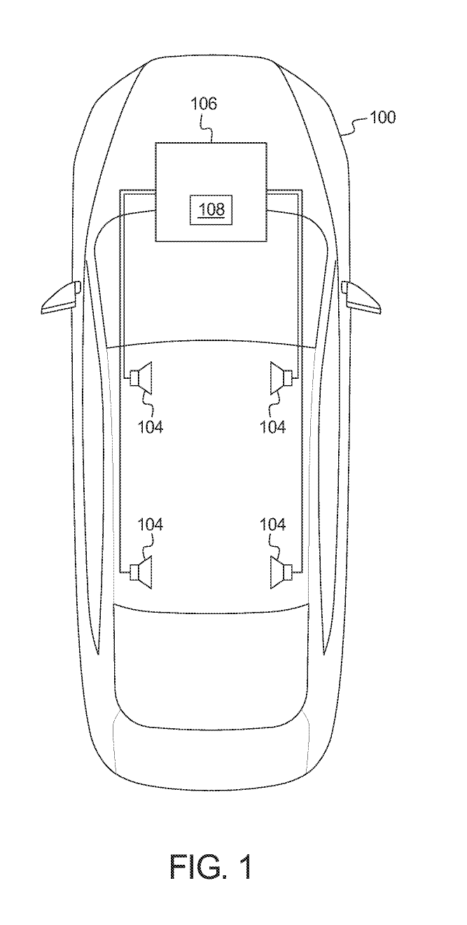

FIG. 1 illustrates a vehicle 100 with operating in accordance with the teachings of this disclosure. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. Additionally, the vehicle 100 may be non-autonomous, semi-autonomous or autonomous. In the illustrated example, the vehicle 100 includes speakers 104 and a sound system 106.

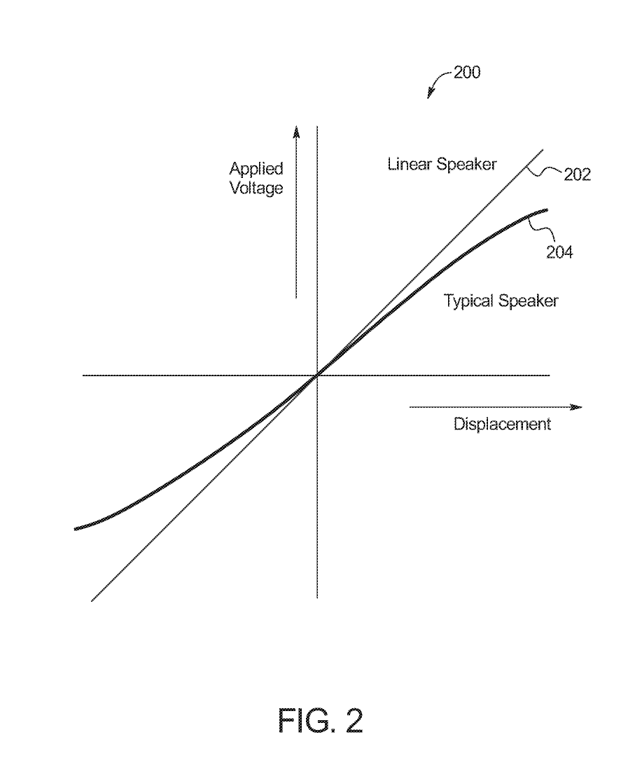

The speakers 104 are vehicle speakers of the same model. While the speakers 104 are the same model, each individual speaker may have slightly different characteristics. The example speakers 104 are built into the doors of the vehicle 100. Additionally or alternatively, in some examples, the speakers 104 are built into a dashboard and/or a center console of the vehicle 100. Additionally, the vehicle 100 may also include tweeters (not shown) and a subwoofer (not shown). FIG. 2 illustrates a graph 200 of a displacement and applied voltage for ideal speakers and actual speakers (e.g. the speakers 104). Ideal speakers are speakers that have a proportional, linear relationship between the displacement of the speaker and the voltage applied to the speaker over the expected range of the speaker. The voltage-displacement response of the ideal speaker is illustrated by line 202 on the graph 200. Non-ideal speakers (e.g., the speakers 104), because of manufacturing, design and material limitations, have a non-linear relationship between the displacement of the speaker and the voltage applied to the speaker over portions of the useful range. The voltage-displacement response of the non-ideal speaker is illustrated by line 204 on the graph 200. For example, at the upper and lower bounds of the non-ideal speaker's displacement, the voltage-displacement response may not be linear. As a result, for example, when voltage is applied to the non-ideal speaker in the non-linear portion of its voltage-displacement response, the sound produced by the non-ideal speaker may be strained and/or distorted.

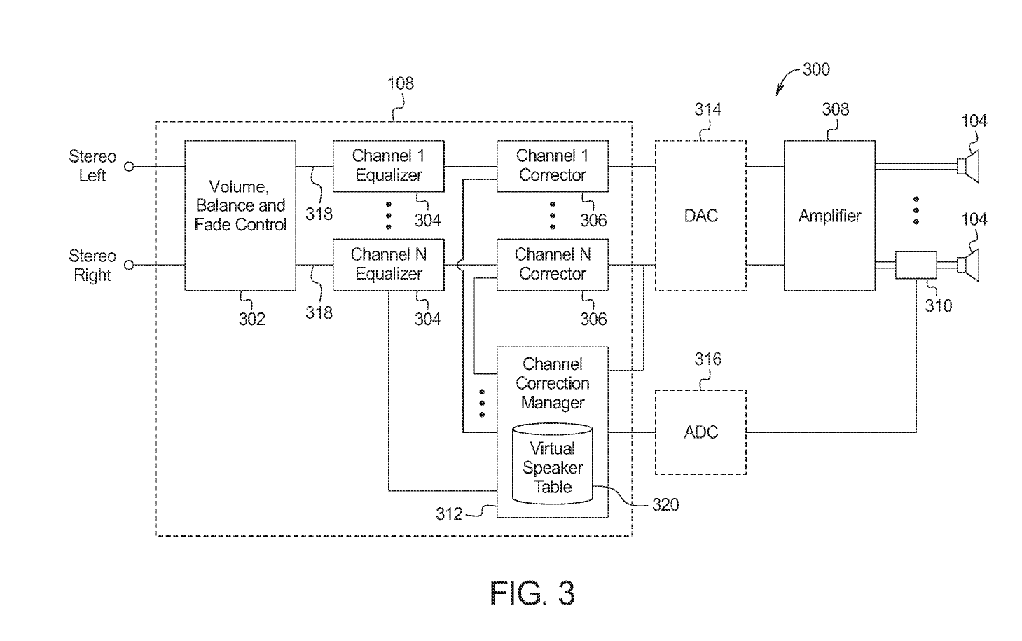

In the illustrated example of FIG. 1, the sound system 106 is coupled to the speakers 104. The sound system 106, as part of an infotainment head unit or standalone amplifier, receives inputs from different sources (e.g., a radio tuner, a mobile device communicatively coupled to the infotainment head unit, applications, etc.) and generates an audio signal to play on the speakers 104. The sound system 106 includes a multi-channel vehicle audio corrector 108. From time to time, the multi-channel vehicle audio corrector 108 samples dynamic current and voltages from one of the speakers 104. As discussed in connection with FIG. 3 below, based on the samples obtained from one of the speakers 104, the multi-channel vehicle audio corrector 108 determines corrections factors for all of the speakers 104. The multi-channel vehicle audio corrector 108 alters the audio signal from the sound system 106 to correct for the non-linear portions of the range of the speakers 104.

FIG. 3 is a block diagram of electronic components 300 of the multi-channel vehicle audio corrector 108 of FIG. 1. In the illustrated example, the multi-channel vehicle audio corrector 108 includes a volume, balance, and fade controller 302, equalizers 304, channel correctors 306, an amplifier 308, a sense circuit 310, and a channel correction manager 312. In some examples, the multi-channel vehicle audio corrector 108 also includes a digital-to-analog convertor (DAC) 314 and/or an analog-to-digital converter (ADC) 316.

The volume, balance, and fade controller 302 receives an audio signal from the sound system 106. In the illustrated example, the audio signal is a stereo audio signal that includes a left stereo signal and a right stereo signal. Alternatively, the audio signal may be a mono audio signal or a surround sound audio signal (e.g., 5.1 audio, 7.1 audio, etc.), etc. The volume, balance, and fade controller 302 adjusts the gain of the corresponding audio signals in audio channels 318. Balance refers to adjusting the gains of the audio channels 318 associated with the speakers 104 on the driver's side of the vehicle 100 in relation to the audio channels 318 associated with the speaker 104 on the passenger's side of the vehicle 100. Fade refers to adjusting the gains of the audio channels 318 associated with the speakers 104 in the front of the vehicle 100 in relation to the audio channels 318 associated with the speaker 104 in the back of the vehicle 100. Volume refers to adjusting the gains of all the audio channels 318 associated with the speakers 104 of the vehicle 100.

The equalizers 304 are associated with a corresponding audio channel 318. The equalizers 304 adjust frequency components of the audio signals of the corresponding audio channel 318 according to equalizer settings of the sound system 106. For example, the equalizer settings of the sound system 106 may be set (e.g. by an occupant of the vehicle 100) to emphasize frequencies in a certain frequency band (e.g., 320 Hz to 1280 Hz, etc.). Additionally, in some examples, the equalizer settings are set during the tuning process of the vehicle and not accessible to the end user.

The amplifier 308 amplifies the audio signals from the channel correctors 306 to currents and voltages (sometimes referred to as “a drive signal”) to cause displacement of diaphragms of the speakers 104 that converts the audio signal into sound. In some examples, the amplifier 308 accepts an analog input and the volume, balance, and fade controller 302, the equalizers 304, and the channel correctors 306 manipulate the audio signal as a digital value. In such examples, the DAC 314 converts the digital output of the channel correctors 306 to an analog input for the amplifier 308. The sense circuit 310 measures the dynamic voltage and current of one of the speakers 104. In some examples, the sense circuit 310 may be integrated into the amplifier 308. In some examples, the sense circuit 310 includes an ADC and is communicatively coupled to the channel correction manager 312 via a digital communication protocol (e.g., RS-232, Inter-Integrated Circuit (I²C), SPI, 1-wire, etc.).

The channel correction manager 312 determines correction factors for the example channel correctors 306. The channel correction manager 312 receives the prediction values from the DAC 314 input corresponding to the speaker 104 that is sampled by the sense circuit 310. The channel correction manager 312 maintains a virtual speaker table 320 that associates predicted values received from the DAC 314 input with the actual values measured by the sense circuit 310. In some examples, initially, the virtual speaker table 320 is initialized as linear (e.g., the actual values equal the corresponding predicted values. Alternatively, in some examples, the virtual speaker table 320 is initially populated through a testing process performed when the vehicle 100 or speaker 104 are manufactured.

From time-to-time, the virtual speaker table 320 is regenerated. In some examples, the channel correction manager 312 continuously updates the virtual speaker table 320 when audio signals are supplied by the sound system 106. Alternatively, in some examples, the channel correction manager 312 causes a calibration signal to be played on the speaker 104 being monitored in response to a triggering event. In such examples, the calibration signal causes the voltages and currents over the range of the speaker 104 to be applied to the speaker 104. In some such examples, the channel correction manager 312 updates the virtual speaker table 320 in response to the ignition switch of the vehicle 100 being set to on (e.g., the triggering event). Additionally the calibration signal, which may or may not be audible to the human ear, may be played at other times, such as when the vehicle is locked and parked.

In some examples, the volume, balance, and fade controller 302, the equalizers 304, the channel correctors 306, and the channel correction manager 312 are implemented by a processor or controller. The processor or controller may be any suitable processing device or set of processing devices such as, but not limited to: a microprocessor, a digital signal processor, a microcontroller-based platform, a suitable integrated circuit, one or more field programmable gate arrays (FPGAs), and/or one or more application-specific integrated circuits (ASICs). Additionally, the processor or controller includes volatile memory (e.g., RAM, which can include non-volatile RAM, magnetic RAM, ferroelectric RAM, and any other suitable forms) and/or non-volatile memory (e.g., disk memory, FLASH memory, EPROMs, EEPROMs, memristor-based non-volatile solid-state memory, etc.). In some examples, the virtual speaker table 320 is stored in non-volatile memory.

The memory is a computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory, the computer readable medium, and/or within the processor during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

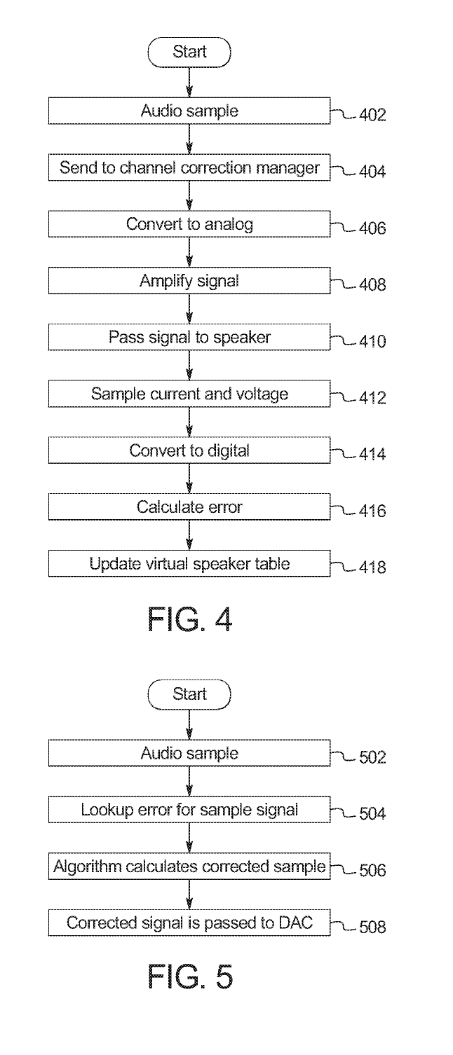

FIG. 4 is a flowchart of a method to populate the virtual speaker table 320. At block 402 the channel corrector 306 presents a calibration signal(s) (e.g., audio samples or specific test signals, etc.) to the example channel DAC 314 associated with the sampled speaker 104. At block 404, the channel corrector 306 sends the calibration signal(s) to the channel correction manager 312. At block 406, the DAC 314 converts the calibration signal(s) to an analog signal. At block 408, the amplifier 308 amplifies the analog signal. At block 410, the amplified analog signal drives the sampled speaker 104. At block 412, the sense circuit 310 measures the resultant current and voltage. At block 414, the ADC 316 converts the current and voltage to a digital signal. At block 416 the channel correction manager 312 calculates the error between the digital signal received from the ADC 316 and the calibration signal received from the channel corrector 306. At block 418 the channel correction manager 312 stores the input (e.g. the calibration signal), the output (the digital signal of the current and voltage) and error values in the virtual speaker table 320.

FIG. 5 is a flowchart of a method to read the virtual speaker table 320 based on sampling one audio channel and apply compensation to all audio channels. At block 502 the channel equalizer 304 forwards the audio signal to the channel correction manager 312. At block 504, the channel correction manager 312 looks up the error value in the virtual speaker table 320 associated with the audio signal received at block 502 and passes the retrieved error value to the channel corrector 306 associated with the affected channel 318. This is repeated for all audio channels in channel equalizer 304. At block 506, the channel correctors 306 use the corresponding actual audio signal and error value received from the channel correction manager 312 to calculate a corrected signal. At block 508, the channel correctors 306 pass the corrected signals from the channel correctors 306 to the DAC 314 to be converted so that the amplifier 308 can amplify the corrected signals to drive the speakers 104.

The flowcharts of FIG. 4 and FIG. 5 are methods that may be implemented by machine readable instructions that comprise one or more programs that, when executed, implement the multi-channel vehicle audio corrector 108 of FIGS. 1 and 3. Further, although the example program(s) is/are described with reference to the flowcharts illustrated in FIGS. 4 and 5, many other methods of implementing the example the multi-channel vehicle audio corrector 108 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A sound system for a vehicle comprising:
a plurality of channel equalizers to generate a plurality of equalized digital audio signals to correspondingly drive a plurality of speakers;
a sensing circuit to monitor analog actual inputs to one of the plurality of speakers;
a channel manager to:
generate correction factors using the actual inputs and corresponding digital predicted inputs of the one of the plurality of speakers;
monitor the plurality of audio signals; and
select correction factors respectively responsive to the plurality of audio signals; and
a plurality of channel correctors corresponding to the plurality of speakers to respectively apply the selected correction factors to the plurality of audio signals.

2. The sound system of claim 1, wherein the channel manager is to maintain, in memory, a virtual speaker table that tracks the predicted inputs and the actual inputs of the one of the plurality of speakers.

3. The sound system of claim 2, wherein the channel manager is to generate the correction factors based on values in the virtual speaker table.

4. The sound system of claim 1, wherein the channel manager is to, in response to a triggering event, cause a calibration signal to drive the one of the plurality of speakers.

5. The sound system of claim 4, wherein the calibration signal drives the one of the plurality of speakers through its operational frequency range.

6. The sound system of claim 4, wherein the channel manager is to generate a virtual speaker table that tracks the predicted inputs and the actual inputs of the one of the plurality of speakers based on the calibration signal.

7. The sound system of claim 4, wherein the triggering event is based on a position of an ignition switch.

8. The sound system of claim 1, wherein each of the plurality of speakers is the same model.

9. A method comprising:
generating, with a processor, multiple audio signals to drive multiple speakers;
monitoring, with a sense circuit, predicted and actual inputs to one of the multiple speakers;
generating, with the processor, correction factors using the predicted and actual inputs;
monitoring, with the processor, the audio signals;
selecting, with the processor, correction factors respectively responsive to the audio signals; and
applying, with the processor, the selected correction factors respectively to the audio signals.

10. The method of claim 9, including maintaining, in memory, a virtual speaker table that tracks the predicted and actual inputs.

11. The method of claim 10, wherein generating the correction factors is based on values in the virtual speaker table.

12. The method of claim 9, including, in response to a triggering event, driving a calibration signal to the one of the multiple speakers.

13. The method of claim 12, wherein the calibration signal drives the one of the multiple speakers through its operational frequency range.

14. The method of claim 12, further including generating a virtual speaker table that tracks the predicted and actual inputs of the one of the multiple speakers based on the calibration signal.

15. The method of claim 12, wherein the triggering event is based on a position of an ignition switch.

16. The method of claim 9, wherein each of the multiple speakers is the same model.

17. A sound system comprising:
a plurality of equalizer circuits to generate digital equalized audio signals to drive a plurality of speakers;
a sense circuit incorporated into an amplifier to monitor analog actual inputs of one of the plurality of speakers;
memory with a virtual speaker table to store the analog actual inputs and corresponding digital predicted inputs; and
a management circuit communicatively coupled to the memory and the sensor to:
generate correction factors based on the virtual speaker table;
monitor the audio signals; and
select correction factors respectively responsive to the audio signals; and
a plurality of correction circuits to respectively apply the selected correction factors to the audio signals.
